(19) United States
(12) Patent Application Publication
(10) Pub. No.: US 2022/0381801 A1
(43) Pub. Date: Dec. 1, 2022

(54) Device for Measuring the Orientation of a Fluid Flow Relative to an Aerodynamic Surface, in Particular of an Aircraft, Using a Magnetic Sensor

(71) Applicant: Airbus Operations S.A.S., Toulouse (FR)

(72) Inventors: Jean-Luc Vialatte, Toulouse (FR); Karounen Veerabadran, Toulouse (FR); Thomas Boisson, Toulouse (FR); Laurent Malard, Toulouse (FR); Ivan Garcia Hallo, Toulouse (FR); Florent Montet, Toulouse (FR)

(73) Assignee: Airbus Operations S.A.S., Toulouse (FR)

(21) Appl. No.: 17/747,353

(22) Filed: May 18, 2022

(30) Foreign Application Priority Data
May 27, 2021 (FR) 2105530

(51) Int. Cl. G01P 13/02; G01P 13/00

(52) U.S. Cl. CPC G01P 13/025; G01P 13/0006; B64C 1/0009

(57) ABSTRACT

The measuring device includes a substrate intended to be arranged on an aerodynamic surface; a profiled element connected at one of its ends to the substrate, and configured to be oriented, under the effect of the fluid flow; a magnet that is secured to the profiled element and is configured to generate a magnetic field; and a measuring element that is configured to measure a value of the magnetic field and to convert this measured value of the magnetic field into an angle value indicating the direction of the fluid flow; the measuring device thus making it possible to measure and provide, in real-time, a numerical angle value with which it is possible to define with high precision the direction of the fluid flow relative to the aerodynamic surface.

### FIELD OF THE INVENTION

The present invention relates to a device for measuring the orientation of a fluid flow relative to an aerodynamic surface, notably of a vehicle and in particular of an aircraft. In the context of the present invention, “fluid flow” is to be understood as the flow of a gaseous fluid, and in particular a flow of air.

### BACKGROUND OF THE INVENTION

In the field of aeronautics, ever-stricter standards and ever-higher client expectations increase requirements in particular in terms of safety, comfort, noise reduction and fuel consumption. For an aircraft, for example a transport plane, these criteria are highly dependent on aerodynamic performance.

The aerodynamic performance of an aircraft can be significantly improved by a clever design for its structure, and in particular for its external surfaces that are exposed to air flows. It is therefore important to have a good understanding of these flows.

A usual method for analyzing the fluid flows, and in general air flows, on the surface of an aircraft or a piece of aircraft equipment or a part of the aircraft, for example a wing, consists in attaching threads (generally nylon or wool) to the surface(s) in question. The aircraft then undergoes testing, either in flight or in a wind tunnel, during which images of the surfaces are recorded, for example using cameras. Through visual observation of the behavior of the threads, under the action of the fluid flows, it is possible to know the direction(s) of the fluid flows and to identify potential separation phenomena.

Nonetheless, this conventional method is not entirely satisfactory. Indeed, modern aircraft have ever more elaborate structures, with complex shapes for which this method is difficult or even impossible to implement, in particular owing to problems in viewing the corresponding regions. However, these complex shapes generally represent regions of significant interest for fluid flow analysis.

Moreover, the image recording devices that must be installed to record the behavior of the threads during testing are heavy and costly, in particular in the case of test flights which sometimes require that one or more other aircraft accompany the test aircraft.

Moreover, and especially, visual observation of the threads does not provide precise numerical measurements that would make it possible to characterize the fluid flows or the separation phenomena. Hence, and in particular, it is not possible to compare test results with numerical simulation results. Furthermore, certain certifications require a level of precision above that of simple visual observation. Moreover, it is also not possible, using this conventional method, to analyze test results in real time.

### BRIEF SUMMARY OF THE INVENTION

An aspect of the invention relates to a device for measuring the orientation of a fluid flow relative to an aerodynamic surface, in particular of an aircraft.

According to an embodiment of the invention, the measuring device comprises at least:
a substrate intended to be arranged on the aerodynamic surface;
a profiled element connected at one of its ends to the substrate, and configured to be oriented, under the effect of the fluid flow, in a direction corresponding to that of said fluid flow;
a magnet that is secured to the profiled element and is configured to generate a magnetic field; and
at least one measuring element that is configured to measure a value of the magnetic field generated by the magnet, which is a function of the direction of the fluid flow.

Moreover, in one preferred embodiment, the measuring unit is configured to convert the measured value of the magnetic field generated by the magnet into an angle value indicative of the direction of the fluid flow.

Thus, an aspect of the invention makes it possible to have a numerical value, specifically said angle value which is defined with respect to a reference axis as set out hereinbelow, which provides a very precise indication of the direction of the fluid flow relative to the aerodynamic surface, in real time.

The measuring device therefore makes it possible to have numerical values that can be used for subsequent processing, for example in order to carry out comparisons with measurements produced by numerical simulations.

Advantageously, the measuring device additionally comprises a processing unit that is configured to process at least the angle values transmitted by the measuring unit. In one particular embodiment, the processing unit is configured to determine, on the basis of the angle value, an aerodynamic behavior criterion among various possible criteria.

In a first embodiment, the profiled element is configured in such a way that it can be oriented in a plane, and the measuring unit is configured to convert the measured value of the magnetic field generated by the magnet into an angle value in said plane.

Furthermore, in one particular embodiment of this first embodiment, the profiled element comprises a fin provided with a protruding element that is configured to form a pivot connection between the profiled element and the substrate.

Moreover, in a second embodiment, the profiled element is configured in such a way that it can be oriented in space, and the measuring unit is configured to convert the measured value of the magnetic field generated by the magnet into an angle value in space.

Furthermore, in one particular embodiment of this second embodiment, the profiled element comprises a cone of revolution provided with an apex, and said cone is attached to the substrate by means of a connecting thread, a first end of the connecting thread being attached to the substrate and a second end of the connecting thread being attached to the apex of the cone.

Furthermore, in one particular embodiment, the measuring unit comprises a magnetic sensor of the microelectromechanical (or MEMS) type.

Moreover, and advantageously, the measuring unit is configured to also transmit, to the processing unit, the measured value of the magnetic field generated by the magnet, and wherein the processing unit is configured to compare this measured value of the magnetic field to a predetermined limit value, and to generate an alert if said measured value of the magnetic field is above this limit value.

Furthermore, in one particular embodiment, the measuring unit comprises at least one auxiliary sensor that is able to measure at least one auxiliary parameter other than the magnetic field, for example temperature or pressure.

### BRIEF DESCRIPTION OF THE DRAWINGS

The appended figures will make it easy to understand how the invention may be implemented. In these figures, identical references denote similar elements.

FIG. 1 is a view in side section of a first embodiment of a device for measuring the orientation of a fluid flow.

FIG. 2 is an exploded perspective view of a measuring device according to this first embodiment.

FIG. 3 is a schematic view of a second embodiment of a device for measuring the orientation of a fluid flow.

FIG. 4 is a schematic perspective view of a magnet and a measuring unit, which serve to illustrate the measuring of the magnetic field generated by the magnet in a plane.

FIG. 5 is a schematic perspective view of a measuring unit, which serves to illustrate the measuring of the magnetic field generated by the magnet in space.

FIG. 6 is a schematic perspective view of a part of an aircraft, showing one wing and one engine, on which measuring units have been installed.

### DETAILED DESCRIPTION

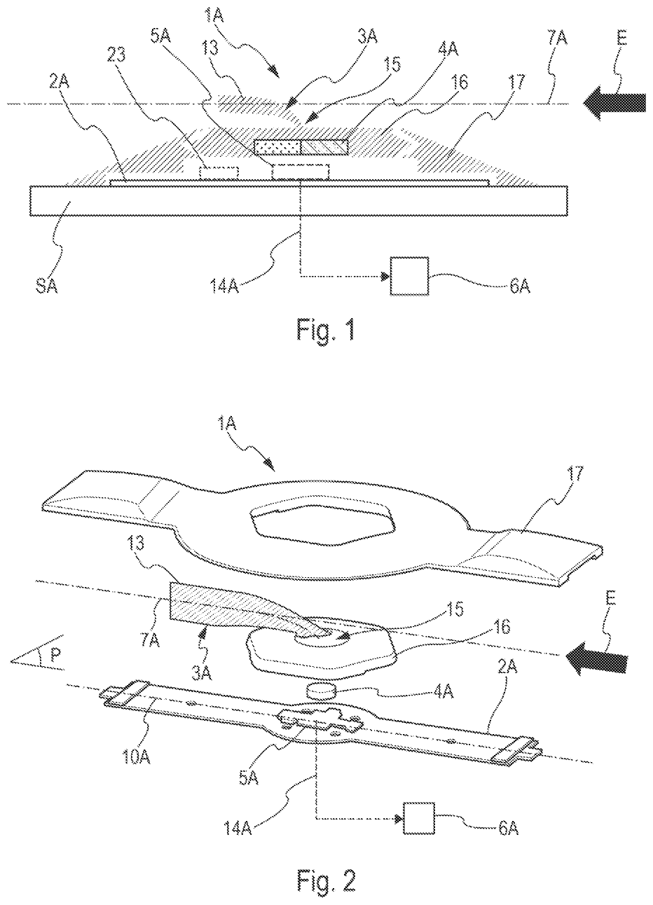

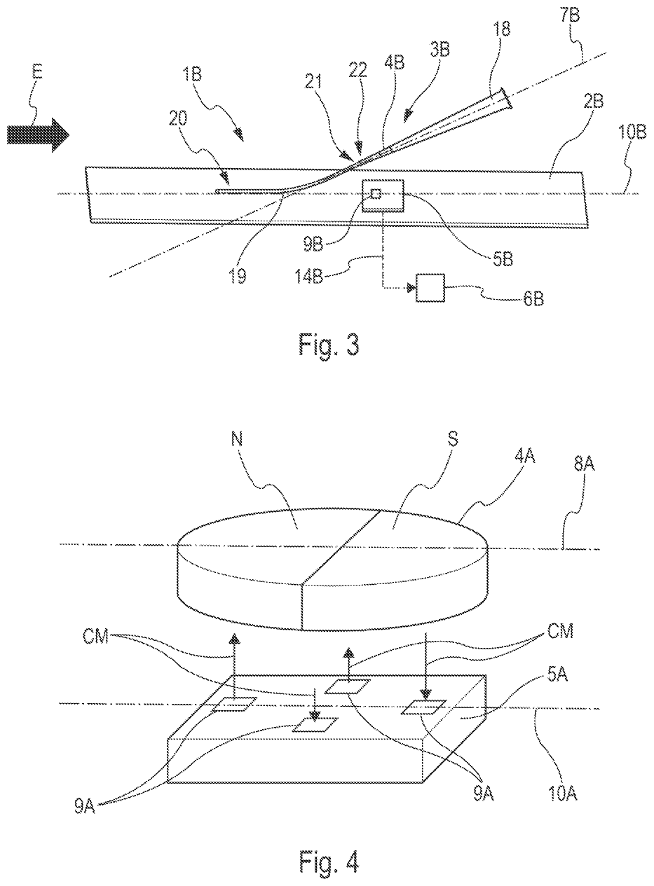

The measuring device serving to illustrate the invention is depicted schematically according to a first embodiment 1A in FIGS. 1 and 2, and according to a second embodiment 1B in FIG. 3. For the sake of clarity, in the following description the elements of the first and second embodiments which serve the same function is are identified using the same reference number (2, 3, 4, . . . ), to which the letter A has been added for the elements of the first embodiment, and the letter B for the elements of the second embodiment.

The measuring device 1A, 1B is intended to measure a parameter of a fluid flow relative to an aerodynamic surface. Although not exclusively, the measuring device 1A, 1B may in particular be used to measure the direction of the fluid flow on an external surface of a part of an aircraft or an item of aircraft equipment, in particular of a transport plane, as set out hereinbelow.

A “fluid flow” is to be understood as the movement of a gaseous fluid over a surface. In the preferred case of the measuring device 1A, 1B being applied to an aircraft, the fluid is assumed to be air and the surface is assumed to be an external surface of the aircraft on which the fluid flows are to be studied.

An “aerodynamic surface” is to be understood as any surface, in particular a surface having a profiled shape, which can be exposed to fluid flows, generally with the aim of promoting lift and minimizing drag. One way of minimizing drag forces is to design an aerodynamic surface which is shaped in such a way that the fluid flows remain attached, that is to say that the streamlines of the flow follow the contours of said surface. Another aim is generally to avoid flow separation which, in aeronautics, can result in undesirable or even dangerous events such as stall.

The purpose of the measuring device 1A, 1B is to measure the orientation of a fluid flow, illustrated by an arrow E in FIGS. 1, 2 and 3, relative to an aerodynamic surface SA.

To that end, the measuring device 1A, 1B comprises, as shown in FIGS. 1, 2 and 3:
a substrate 2A, 2B intended to be arranged on the aerodynamic surface SA;
a profiled element 3A, 3B, which is namely elongate, which is connected at one of its ends to the substrate 2A, 2B and which is configured such that it can be oriented, under the effect (or action) of the fluid flow, and more particularly to be oriented in a direction which corresponds to the direction of the fluid flow;
a magnet 4A, 4B that is secured to the profiled element 3A, 3B and is configured to generate a magnetic field CM. The magnet 4A, 4B that is secured to the profiled element 3A, 3B is therefore subjected, where relevant, to the same movement as the profiled element 3A, 3B under the action of the fluid flow, and when it moves the magnetic field CM which it generates will vary according to the given point on the surface; and
a measuring unit 5A, 5B that is configured to measure the value of the magnetic field CM generated by the magnet 4A, 4B. This value is therefore a function of the direction of the fluid flow.

Furthermore, the measurement unit 5A, 5B is configured to convert this measured value (of the magnetic field CM) into a numerical value, specifically an angle value indicative of the direction of the fluid flow, and to transmit this angle value.

The measuring device 1A, 1B also comprises a processing unit 6A, 6B that is connected via a connection 14A, 14B, preferably a wired connection, to the measuring unit 5A, 5B. The processing unit 6A, 6B is configured to process at least the angle values transmitted by the measuring unit 5A, 5B via the connection 14A, 14B.

In one variant embodiment, the measuring unit 5A, 5B is configured to transmit the measured value of the magnetic field CM, the latter being converted into an angle value indicating the direction of the fluid flow by means of a computing unit that is external to the measuring device 1A, 1B, for example by means of the processing unit 6A, 6B.

In another variant embodiment, the measuring unit 5A, 5B is configured to store the measured values of the magnetic field CM (and possibly the angle values) with a view to subsequent processing carried out for example by the processing unit 6A, 6B.

Furthermore, the processing unit 6A, 6B is also able to determine an aerodynamic behavior criterion on the basis of the angle values transmitted by the measuring unit 5A, 5B, as set out hereinbelow.

In one preferred embodiment, the measuring unit 5A, 5B takes the form of a magnetic sensor of the microelectromechanical (or MEMS) type.

In the first embodiment of FIGS. 1 and 2, the substrate 2A is made of a flexible material so that it can match the shape of the aerodynamic surface SA. Thus, the measuring device 1A can adapt to various shapes of aerodynamic surface, in particular curved shapes. Furthermore, the thickness of the substrate 2A is preferably less than one millimetre in order to minimize the overall frontal surface area of the measuring device 1A, and thus not disrupt the fluid flow.

In the embodiment shown in FIGS. 1 and 2, the profiled element 3A comprises a fin 13, the fin 13 being provided with an end that is formed to create a pivot connection between the profiled element 3A and the substrate 2A. This pivot connection allows the fin 13 to move freely in rotation in the plane of the aerodynamic surface SA. Furthermore, this pivot connection is configured to reduce friction as much as possible.

In this first embodiment, the fin 13 of the profiled element 3A preferably has an elongate profiled shape, having a longitudinal axis 7A that is representative of its orientation. The profiled element 3A is configured so that its movement under the effect of the fluid flow orients the longitudinal axis 7A in the same direction as the direction E of the fluid flow. The orientation of the longitudinal axis 7A of the profiled element 3A that is exposed to the fluid flow therefore corresponds to the orientation of said fluid flow.

In the example of FIGS. 1 and 2, the fin 13 is made for example of plastic or of polymer and is connected by a base element 15 to a support part 16. The support part 16 is secured to the substrate 2A, and the base element 15 is mounted so as to be able to rotate relative to the support part 16. The magnet 4A is integrated into this base element 15 of the profiled element 3A.

The measuring device 1A also comprises, in this example, a fairing 17 that surrounds the support part 16 and the measuring unit 5A. This fairing 17 serves to ensure geometric continuity between the aerodynamic surface SA and the surfaces of the measuring device 1A that are exposed to the fluid flow. The fairing 17 has, in particular, a flattened and slightly domed shape in order to minimize the disruption to the fluid flow caused by the measuring device 1A. In particular, the fairing 17 is configured to be arranged on the substrate 2A and to cover the components of the measuring device 1A, with the exception of the fin 13.

Moreover, the magnet 4A is a micro-magnet, that is to say a very small (millimeter-scale) cylindrical magnet. As shown in FIG. 4, the magnet 4A has a north pole N and a south pole S, which correspond to two half-cylinders of the magnet 4A. The magnetic field CM generated by a cylindrical magnet 4A of this kind is, on one hand, fixed and constant with respect to the magnet 4A and, on the other hand, is symmetric with respect to a north-south axis 8A defined by the two poles of the magnet 4A. However, the magnet 4A is secured to the profiled element 3A and therefore always has the same orientation with respect to the profiled element 3A. As a consequence, the magnetic field CM itself also always has the same orientation with respect to the profiled element 3A.

In one particular embodiment, the magnet 4A is arranged on the profiled element 3A in such a way the north-south axis 8A (FIG. 4) of the magnet 4A is aligned with the longitudinal axis 7A (FIGS. 1 and 2) of the profiled element 3A. The magnetic field CM generated by the magnet 4A is therefore symmetric with respect to the longitudinal axis 7A of the profiled element 3A.

In the particular embodiment depicted in FIG. 4, the measuring unit 5A comprises four magnetic sensors 9A that are able to measure a value of the magnetic field CM generated by the magnet 4A. Furthermore, the measuring unit 5A is arranged on the substrate 2A, preferably directly beneath the profiled element 3A.

The measurement unit 5A comprises an integrated computing unit (not shown) which is configured to compare the values of the magnetic field CM to one another, these values having been measured by the magnetic sensors 9A, and to calculate an angle value in the usual way, on the basis of the result of this comparison. In one particular embodiment, the measuring unit 5A comprises a reference axis 10A, and is configured in such a way that the calculated angle value corresponds to the value, in degrees, of the angle formed by the north-south axis 8A of the magnet 4A and said reference axis 10A.

In this first embodiment, the profiled element 3A is configured to be able to be oriented in a plane P (FIG. 2). Preferably, the plane P corresponds to a plane parallel to the plane that is tangential to the aerodynamic surface SA passing through the reference axis 10A.

In this first embodiment, the at least one measuring element 5A is configured to convert the value of the magnetic field CM generated by the magnet 4A into an angle value in the plane P. This angle value then corresponds to the planar angle (in two dimensions) formed by the reference axis 10A of the measuring unit 5A and the direction E of the fluid flow in the plane P. This angle value is transmitted by the measuring unit 5A to the processing unit 6A.

Furthermore, in one particular embodiment, the processing unit 6A is configured to determine an aerodynamic behavior criterion on the basis of the angle values transmitted by the measuring unit 5A. When applied to an aircraft, as described hereinbelow with reference to FIG. 6, three aerodynamic behavior criteria, which are defined as a function of the angle values transmitted by the measurement unit 5A, are considered. More precisely:
if the profiled element 3A, exposed to the fluid flow, adopts a stable direction, with very little variation over time (of the order of plus or minus one degree), the fluid flow is considered to be attached;
if the profiled element 3A, exposed to the fluid flow, oscillates about a given direction with an angle that does not exceed 35° with respect to this direction, the fluid flow is considered to be turbulent; and
if the profiled element 3A, exposed to the fluid flow, does not adopt a direction that is stable over time, or oscillates about a given direction with an angle that exceeds 35° with respect to this direction, the fluid flow is considered to have separated.

The measuring device 1A, as described hereinabove, comprising a profiled element 3A provided with a fin 13 and a measuring unit 4A that takes two-axis measurements (in a plane) is particularly well-suited to high-velocity fluid flow measurements. It is also advantageous for applications requiring high precision, since it makes it possible to measure the orientation of the fluid flow with degree-scale precision (for the angle values).

Furthermore, in the second embodiment depicted in FIG. 3, the profiled element 3B is configured in such a way that it can be oriented in space.

In this second embodiment, the profiled element 3B is provided with a cone (of revolution) 18 that is made for example of plastic. The cone 18 of the profiled element 3B has a longitudinal axis 7B. The profiled element 3B is configured so that its movement under the effect of the fluid flow orients the longitudinal axis 7B in the same direction as the direction E of the fluid flow. The orientation of the longitudinal axis 7B of the profiled element 3B that is exposed to the fluid flow therefore corresponds to the orientation of said fluid flow.

The profiled element 3B is connected to the substrate 2B via a connecting thread 19, for example a nylon thread. A first end 20 of the connecting thread 19 is attached to the substrate 2B, for example by means of glue and/or another adhesive. The second end 21 of the connecting thread 19 is attached to the apex 22 of the cone 18.

The magnet 4B is preferably arranged inside the cone 18, close to the apex 22 thereof.

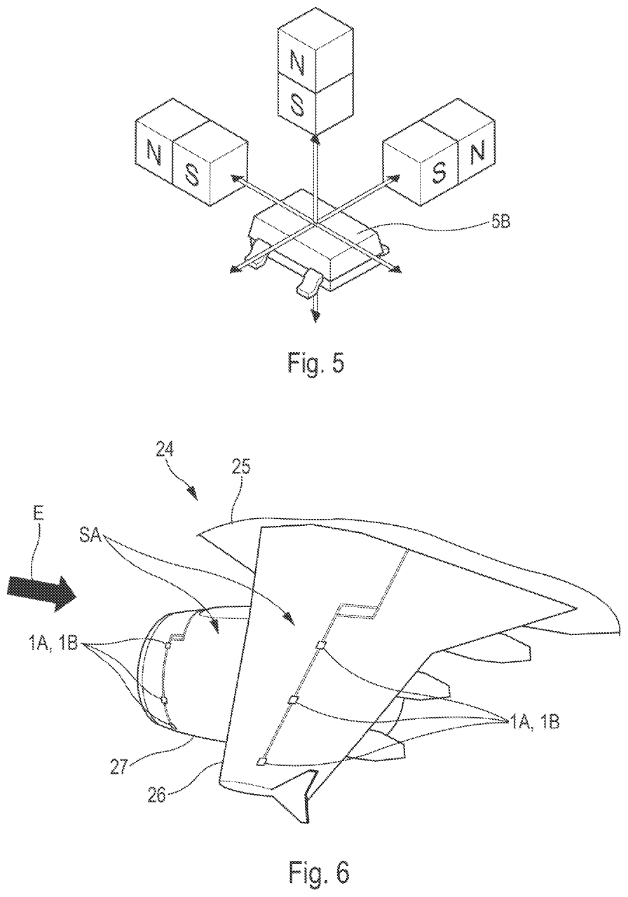

In this second embodiment, the measuring unit 5B, which is illustrated schematically and in part in FIG. 5, is configured to convert, in the usual manner, the value of the magnetic field CM generated by the magnet 4B into an angle value in space. The angle value then corresponds to the angle formed by a reference axis 10B of the measuring unit 5B and the direction E of the fluid flow.

The measuring device 1B, as described hereinabove, comprising a profiled element 3B provided with a cone 18 and a measuring unit 4B that takes three-axis measurements (in space), is particularly well-suited to moderate-velocity fluid flow measurements. In particular, it is well-suited to detecting separation phenomena since it serves to measure fluid flow angle values in directions outside the plane that is tangential to the aerodynamic surface SA.

There follows a description of the installation of a measuring device 1A, 1B on an aerodynamic surface SA (at which the behavior of a fluid flow is to be analyzed, for example a surface of a part of an aircraft as set out hereinbelow with reference to FIG. 6), and of the operation thereof.

When the measuring device 1A, 1B is put in place, it is arranged on the aerodynamic surface SA by attaching the substrate 2A, 2B to said aerodynamic surface SA with glue or other adhesive means. Furthermore, the measuring device 1A, 1B is arranged in such a way that the reference axis 10A, 10B of the measuring unit 5A, 5B is oriented in a direction, termed reference direction, of the aerodynamic surface SA.

The reference direction is a direction which can be chosen arbitrarily and which defines the direction in which the measuring device 1A, 1B is to measure an angle value of 0°. Example, in the case of a mainly unidirectional fluid flow, the reference direction may correspond to the general direction of said fluid flow.

There follows an explanation of the operation of the measuring device 1A, 1B arranged on the aerodynamic surface SA and exposed to a fluid flow.

The forces exerted by the fluid flow on the faces of the profiled element 3A, 3B make the latter move with respect to the substrate 2A, 2B in such a way that the longitudinal axis 7A, 7B of said profiled element 3A, 3B adopts the same orientation as that of the fluid flow.

The magnet 4A, 4B that is secured to the profiled element 3A, 3B adopts the same orientation as the fluid flow, which changes the orientation of the magnetic field CM generated by the magnet 4A, 4B at a given point of the aerodynamic surface SA. The effect of this is to change the magnetic field value measured by the magnetic sensors 9A, 9B of the measuring unit 5A, 5B. The change in magnetic field value, caused by the change in the orientation of the magnet 4A, 4B, is processed by the measuring unit 5A, 5B in order to determine an angle value.

The angle value determined by the measuring unit 5A, 5B is the value of the angle formed by the reference axis 10A, 10B of the measuring unit 5A, 5B and the orientation of the magnetic field CM, that is to say the orientation of the magnet 4A, 4B. However, the orientation of the magnet 4A, 4B corresponds to the orientation of the profiled element 3A, 3B, which corresponds to the orientation of the fluid flow. Moreover, since the reference axis 10A, 10B of the measuring unit 5A, 5B is for example arranged according to a reference direction of the aerodynamic surface, as indicated hereinabove, the angle value determined by the computing unit 12A, 12B corresponds to the angle between the orientation of the fluid flow and this reference direction.

In one particular application, the measuring device 1A, 1B has a frequency of acquisition that allows it to measure and provide the angle values at a high rate, for example at a rate of 15 measurements per second, which makes it possible to have a dynamic and usable representation of the changes in the fluid flow over time.

Furthermore, in one particular embodiment, the measuring unit 5A, 5B is configured to also provide the measured value of the magnetic field (generated by the magnet 4A, 4B) the processing unit 6A, 6B, in addition to the angle value. In this case, the processing unit 6A, 6B can for example compare this measured magnetic field value to a predetermined limit value, and generate an alert if said measured magnetic field value exceeds this limit value.

The fact that the processing unit 6A, 6B takes into account the measured value of the magnetic field makes it possible to have a physical quantity other than just the angle value. It is not necessarily easy, using only the angle value transmitted by the measuring unit 5A, 5B, to detect a defect in the measuring device 1A, 1B, or interference in the measured magnetic field. For example, in the case of the measuring device 1A, 1B being applied to the analysis of the aerodynamic surfaces of an aircraft, it is possible for the measuring device 4A, 4B to be positioned close to an item of electrical equipment of said aircraft, that generates a stray magnetic field. In this case, the stray magnetic field can interfere with the measurement of the magnetic field CM by the measuring unit 5A, 5B, and lead to an erroneous angle value being transmitted. Since the magnet 4A, 4B and the value of the magnetic field which it generates are known, the processing unit 6A, 6B is able to identify an inconsistent measured value of the magnetic field, and thus to deduce therefrom that the corresponding angle value is incorrect and that it should not be taken into account.

Furthermore, in one particular embodiment, the measuring unit 5A, 5B comprises at least one auxiliary sensor that is able to measure an auxiliary parameter other than the magnetic field, such as a temperature sensor 23 shown in FIG. 1.

The temperature sensor 23 is able to measure the temperature of at least one component of the measuring device 1A, 1B, or of the environment of the measuring device 1A, 1B, and to transmit the measured temperature value to the processing unit 6A, 6B, for example via the connection 14A, 14B. The processing unit 6A, 6B may use this temperature value for various applications. In particular it may compare it to a predetermined limit value, for example 85° C., and generate an alert message if the measured temperature value exceeds this limit value.

This embodiment makes it possible to detect an abnormal temperature at the measuring device 1A, 1B, which may be indicative of a fault in said measuring device 1A, 1B, or a component thereof. An excessively high value of the temperature of the component may serve as an alert, which may for example imply that the angle values provided by the measuring device 1A, 1B should not be taken into account.

The measuring unit 5A, 5B may also comprise, as an auxiliary sensor, a pressure sensor (not shown) that is able to measure the static pressure generated by the fluid flow on the aerodynamic surface.

The measuring device 1A, 1B as described hereinabove is therefore particularly advantageous. In particular, it makes it possible to measure and provide, in real time, a (numerical) angle value which is defined with respect to a known reference direction and which indicates with high precision the direction of a fluid flow on an aerodynamic surface.

The measuring device 1A, 1B therefore makes it possible to provide very precise numerical measurements that serve for characterizing the fluid flows and in particular flow separation phenomena. These numerical values can be used for carrying out subsequent processing, such as comparisons with numerical simulations. The provided angle values also make it possible to determine a criterion (attached, unstable, separated) that is characteristic of the aerodynamic behavior of the analyzed flow.

Furthermore, the high precision of the obtained angle values may for example make it possible to meet, where relevant, the strict requirements for certain certifications, for example of an aircraft.

A preferred application for the measuring device 1A, 1B, as illustrated in FIG. 6, is the analysis of fluid flows on the external surfaces of an aircraft 24, in particular of a transport plane. The example shown in FIG. 6 also depicts a part of the aircraft 24, comprising a wing 26 that is attached to a fuselage 25, and an engine 27 that is mounted beneath the wing 26. In this example, a plurality of measuring devices 1A, 1B are arranged on the aerodynamic surfaces SA of these elements, and in particular on the upper surface of the wing 26 and around the outer face of the engine 27, close to the air intake.

Advantageously, the measuring device 1A, 1B may be implemented on aerodynamic surfaces that are difficult to observe visually, such as the internal surfaces of an engine, the underside of a wing or surfaces of horizontal or vertical stabilizers.

In one particular application, the measuring device 1A, 1B is implemented as a testing tool in processes for designing or validating aerodynamic structures. The measuring device 1A, 1B is arranged on aerodynamic surfaces of an aircraft, the model or of an item of equipment whose behavior in a fluid flow is to be studied in the context of testing.

In a first type of test, the structure that is to be tested is an aircraft that is intended to carry out a test flight. The measuring device 1A, 1B is then arranged on that or those aerodynamic surface(s) of the structure for which the fluid flow is to be studied. A plurality of devices 1A, 1B may be arranged on said surfaces in order to create a mesh that makes it possible to analyze the behavior of the fluid flow over an entire region. The aircraft then carried out a test flight during which these surfaces are exposed to airflow. The measuring device(s) 1A, 1B provide angle values and aerodynamic behavior values that serve to characterize the airflow with respect to the analyzed surfaces, this being done in real time.

Moreover, in a second type of test, the structure that is to be tested undergoes testing in a wind tunnel. One or more devices 1A, 1B are arranged on the aerodynamic surfaces of the structure that is to be analyzed. The structure is then arranged in the wind tunnel in order to be exposed to a controlled fluid flow, defined by a test protocol. The measuring device(s) 1A, 1B provide angle values and aerodynamic behavior values that serve to characterize the fluid flow with respect to the analyzed surfaces.

However, the use of the measuring device 1A, 1B, as described hereinabove, is not restricted to the field of aeronautics. Indeed, it may be used as a tool for analyzing the behavior of a fluid flow with respect to an aerodynamic surface, in any application that involves a structure exposed to a fluid flow.

The measuring device 1A, 1B may in particular be used to analyze the air flow over surfaces of vehicles such as land-based vehicles, in particular in the automotive and rail-transport fields, or flying devices, in particular in the field of ballistics.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for measuring the orientation of a fluid flow relative to an aerodynamic surface, said measuring device comprising:
a substrate configured to be arranged on the aerodynamic surface;
a profiled element connected at one of its ends to the substrate, and configured to be oriented, under the effect of the fluid flow, in a direction corresponding to that of said fluid flow;
a magnet secured to the profiled element and configured to generate a magnetic field; and
at least one measuring element configured to measure a value of the magnetic field generated by the magnet, wherein the value of the magnetic field is a function of the direction of the fluid flow.

2. The measuring device as claimed in claim 1, wherein the at least one measuring element is configured to convert the measured value of the magnetic field generated by the magnet into an angle value indicative of the direction of the fluid flow.

3. The measuring device as claimed in claim 2, further comprising a processing unit configured to process at least angle values transmitted by the measuring unit.

4. The measuring device as claimed in claim 3, wherein the processing unit is configured to determine, on the basis of the angle value, an aerodynamic behavior criterion.

5. The measuring device as claimed in claim 1, wherein the profiled element is configured so as to be oriented in a plane, and wherein the measuring unit is configured to convert the measured value of the magnetic field generated by the magnet into an angle value in said plane.

6. The measuring device as claimed in claim 5, wherein the profiled element comprises a fin provided with a protruding element configured to form a pivot connection between the profiled element and the substrate.

7. The measuring device as claimed in claim 1, wherein the profiled element is configured so as to be oriented in space, and wherein the measuring unit is configured to convert the measured value of the magnetic field generated by the magnet into an angle value in the space.

8. The measuring device as claimed in claim 7, wherein the profiled element comprises a cone of revolution provided with an apex, and wherein said cone is attached to the substrate by a connecting thread, a first end of the connecting thread attached to the substrate and a second end of the connecting thread attached to the apex of the cone.

9. The measuring device as claimed in claim 3, wherein the measuring unit is configured to also transmit, to the processing unit, the measured value of the magnetic field generated by the magnet, and wherein the processing unit is configured to compare the measured value of the magnetic field to a predetermined limit value, and to generate an alert if said measured value of the magnetic field exceeds this limit value.

10. The measuring device as claimed in claim 1, wherein the measuring unit comprises at least one auxiliary sensor configured to measure at least one auxiliary parameter other than the magnetic field.
